(19) United States
(12) Patent Application Publication
(10) Pub. No.: US 2025/0210041 A1
(43) Pub. Date: Jun. 26, 2025

(54) SYSTEM, METHOD, AND RECORDING MEDIUM HAVING RECORDED THEREON A COMPUTER PROGRAM FOR DIALOGUE OPERATION ASSISTANCE

(71) Applicant: Umee Technologies Inc., Tokyo (JP)

(72) Inventors: Hirotaka Niiro, Tokyo (JP); Atsushi Nakajima, Chiba (JP); Shuichi Hirai, Kanagawa (JP)

(21) Appl. No.: 18/848,307

(22) PCT Filed: Mar. 18, 2022
(86) PCT No.: PCT/JP2022/012828

§ 371 Date: Sep. 18, 2024

(51) Int. Cl. G10L 15/22; G10L 15/26; G10L 25/63

(52) U.S. Cl. CPC G10L 15/22; G10L 15/26; G10L 25/63

(57) ABSTRACT

Provided is a dialogue operation assistance system comprising: a conversation log display information generation unit that generates display information for displaying a conversation log acquired of a conversation between a user and the user's conversation partner; a task set display information generation unit that generates display information for displaying a plurality of task fields in an order in which a plurality of tasks should be performed, the plurality of task fields each corresponding to the plurality of tasks which are set in the order in which the plurality of tasks should be performed; and a task state display information generation unit that, if it is determined for at least one task of the plurality of tasks that an utterance of the user, an image, an utterance of the user's conversation partner, or an image of the user's conversation partner is relevant to any of one or more types of feature points in the conversation, generates display information for displaying indicators respectively corresponding to the one or more types of feature points, in a task field each corresponding to the at least one task. In response to any of the indicators being pressed, the conversation log display information generation unit generates display information for displaying the conversation log, focussing on an utterance of the user or an utterance of the user's conversation partner in the conversation log which corresponds to the feature point of the pressed indicator.

### TECHNICAL FIELD

The present invention relates to a system, a method and a program for dialogue operation assistance, and a recording medium in which the program is recorded.

### BACKGROUND ART

A technique of displaying, along a time axis, a text of a conversation which underwent speech recognition and a speech waveform, in order to confirm the conversational content which took place in a dialogue operation has been proposed (refer, e.g., to Patent Literature 1 below).

### CITATION LIST

### Patent Literature

Patent Literature 1: JP 5685702 B2

### SUMMARY OF INVENTION

### Technical Problem

However, in the technique according to aforementioned Cited Literature 1, when the conversation becomes long, many complicated operations such as scrolling through the screen image or enlarging/reducing the size of the screen image become necessary in order for the user to find the sections he/she wishes to confirm. Moreover, although detailed information of the conversation is obtainable, it is difficult to grasp with one glance an overview of the flow and content of a conversation which took place.

Thus, one of the objectives of the present invention is to provide a system, method, program, and recording medium in which the program is recorded, in which an overview of the flow and content of a conversation that took place in a dialogue operation can be easily grasped, whilst details of sections of a conversation that a user wishes to confirm can also be easily grasped.

### Solution to Problem

An aspect of the present invention is to provide a dialogue operation assistance system for assisting a dialogue operation in which a user is engaged, where the system is provided with: a conversation log display information generation unit that generates display information for displaying a conversation log acquired of a conversation between the user and the user's conversation partner; a task set display information generation unit that generates display information for displaying a plurality of task fields in an order in which a plurality of tasks should be performed, the plurality of task fields respectively corresponding to the plurality of tasks which are set in the order in which the plurality of tasks should be performed; and a task state display information generation unit that, if it is determined for at least one task of the plurality of tasks that an utterance of the user, an image of the user, an utterance of the user's conversation partner, and/or an image of the user's conversation partner is relevant to any of one or more types of feature points in a conversation, generates display information for displaying indicators respectively corresponding to the one or more types of feature points, in task fields each corresponding to the at least one task. In response to any of the indicators being pressed, the conversation log display information generation unit generates display information for displaying the conversation log, focussing on an utterance of the user and/or an utterance of the user's conversation partner in the conversation log which corresponds to the feature point of the pressed indicator.

The task set display information generation unit may generate display information for displaying a phase field in the order in which the phase field, which was set, should be performed, where the phase field corresponds to a phase configured from one or more of the plurality of tasks.

The conversation log may be conversation text data obtained by speech recognition of a speech signal of a conversation between the user and the user's conversation partner.

The task state display information generation unit may generate display information for displaying information on a task undertaken and/or information on a task not undertaken, in a task field corresponding to a task determined to be a task which was undertaken and/or a task which was not undertaken.

The task state display information generation unit may generate display information for displaying at least one of a starting time of a task, an ending time of a task, and a handling time for a task, in a task field corresponding to a task of which at least one of the starting time, ending time, and handling time for a task is determined.

The feature point of the indicator may be that a task starting condition is satisfied.

The feature point of the indicator may be a point of change in emotions and/or a point of change in conversation speed.

An aspect of the present invention is to provide a dialogue operation assistance method performed by a computer for assisting a dialogue operation in which a user is engaged, where the method includes: generating display information for displaying a conversation log acquired of a conversation between the user and the user's conversation partner; generating display information for displaying a plurality of task fields in an order in which a plurality of tasks should be performed, the plurality of task fields respectively corresponding to the plurality of tasks which were set in the order in which the plurality of tasks should be performed; if it is determined for at least one task of the plurality of tasks that an utterance of the user, an image of a user, an utterance of the user's conversation partner, and/or an image of a user's conversation partner fall under to any of one or more types of feature points in a conversation, generating display information for displaying indicators respectively corresponding to the one or more types of feature points, in a task field each corresponding to the at least one task; and in response to any of the indicators being pressed, generating display information for displaying the conversation log, focussing on an utterance of the user and/or an utterance of the user's conversation partner in the conversation log which corresponds to the feature point of the pressed indicator.

The dialogue operation assistance method may further include generating display information for displaying a phase field in the order in which the phase field, which was set, should be performed, where the phase field corresponds to a phase configured from one or more of the plurality of tasks.

The conversation log may be conversation text data obtained by speech recognition of a speech signal of a conversation between the user and the user's conversation partner.

The dialogue operation assistance method may further include generating display information for displaying information on a task undertaken and/or information on a task not undertaken, in a task field corresponding to a task determined to be a task which was undertaken and/or a task which was not undertaken.

The dialogue operation assistance method may further include generating display information for displaying at least one of a starting time of a task, an ending time of a task, and a handling time for a task, in a task field corresponding to a task of which at least one of the starting time, ending time, and handling time for a task was determined.

The feature point of the indicator may be that it a task starting condition is satisfied.

The feature point of the indicator may be a point of change in emotions and/or a point of change in conversation speed.

An aspect of the present invention is to provide a program for performing the dialogue operation assistance method on a computer.

An aspect of the present invention is to provide a computer readable recording medium on which the program is recorded.

An aspect of the present invention is to provide a method for generating a dialogue operation assistance system by installing the program on the computer.

### Advantageous Effects of Invention

According to the present invention having the aforementioned configuration, a system, method, program, and recording medium in which the program is recorded can be provided, in which an overview of the flow and content of a conversation that took place in a dialogue operation can be easily grasped, whilst details of sections of a conversation that a user wishes to confirm can also be easily grasped.

### BRIEF DESCRIPTION OF DRAWINGS

FIG. 1 illustrates an entire configuration of a dialogue operation assistance system according to an embodiment of the present invention.

FIG. 2 illustrates a hardware configuration of a dialogue operation assistance system according to an embodiment of the present invention.

FIG. 3 is one example of a schematic flowchart of a dialogue operation assistance process according to an embodiment of the present invention.

FIG. 4 is one example of a flowchart of a speech-related information acquisition process according to an embodiment of the present invention.

FIG. 5A is one example of a flowchart of a display information generation and phase/task transition monitoring process according to an embodiment of the present invention.

FIG. 5B is one example of a flowchart of a display information generation and phase/task transition monitoring process according to an embodiment of the present invention.

FIG. 5C is one example of a flowchart of a display information generation and phase/task transition monitoring process according to an embodiment of the present invention.

FIG. 5D is one example of a flowchart of a display information generation and phase/task transition monitoring process according to an embodiment of the present invention.

FIG. 6 illustrates one example of a display screen displayed on a display of a user terminal according to an embodiment of the present invention.

FIG. 7 illustrates one example of a conversation log window displayed on a display of a user terminal according to an embodiment of the present invention.

FIG. 8 illustrates one example of a conversation log window displayed on a display of a user terminal according to an embodiment of the present invention.

FIG. 9 illustrates a next phase table according to an embodiment of the present invention.

FIG. 10 illustrates a starting condition keyword table according to an embodiment of the present invention.

FIG. 11A is one example of a flowchart of the browsing process according to an embodiment of the present invention.

FIG. 11B is one example of a flowchart of the browsing process according to an embodiment of the present invention.

### DESCRIPTION OF EMBODIMENTS

One embodiment of the present invention will be explained below referring to the drawings.

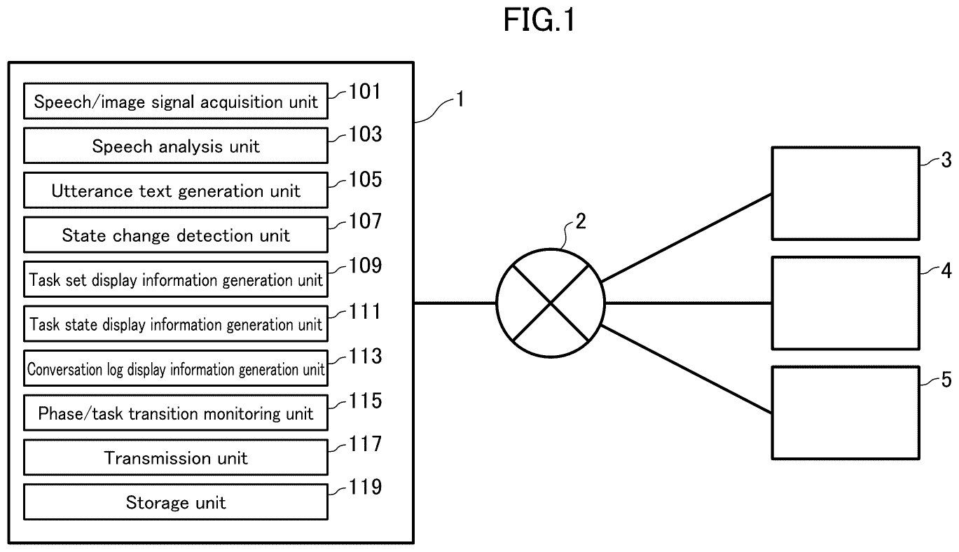

FIG. 1 illustrates an entire configuration of a dialogue operation assistance system according to an embodiment of the present invention. The dialogue operation assistance system 1 is connected via a network 2 to a user terminal 3, a client terminal 4 which is a terminal of a client who is a conversation partner of a user, and an administrator terminal 5 which is a terminal of an administrator such as a supervisor, etc. of a user. The dialogue operation assistance system 1, user terminal 3, client terminal 4, and administrator terminal 5 need not each be configured as one physical apparatus, but may also be configured from a plurality of physical apparatuses.

Any suitable terminal provided with a microphone and camera as well as having a data communication function, such as a PC, smartphone, tablet terminal, etc. can be used as the user terminal 3, client terminal 4 and administrator terminal 5.

The dialogue operation assistance system 1 is provided with a speech/image signal acquisition unit 101, a speech analysis unit 103, an utterance text generation unit 105, a change of state detection unit 107, a task set display information generation unit 109, a task state display information generation unit 111, a conversation log display information generation unit 113, a phase/task transition monitoring unit 115, a transmission unit 117, and a storage unit 119. The dialogue operation assistance system 1 need not be configured as one physical apparatus, but may also be configured from a plurality of physical apparatuses.

The speech/image signal acquisition unit 101 acquires a speech signal of a conversation between a user and a user's conversation partner, an image signal of an image shot of a user in a conversation between a user and a user's conversation partner, and/or an image signal of an image shot of a user's conversation partner in a conversation between a user and a user's conversation partner.

The speech analysis unit 103 specifies an utterance section of a user and an utterance section of a user's conversation partner, by performing speech analysis of a speech signal acquired by the speech/image signal acquisition unit 101 of a conversation between a user and a user's conversation partner, and by detecting an utterance section and performing speaker identification.

The utterance text generation unit 105 generates an utterance text by performing speech recognition on the specified speech signals of an utterance section of a user and an utterance section of a user's conversation partner.

For a speech signal of the specified utterance section of a user, speech signal of the specified utterance section of a user's conversation partner, utterance text generated by speech recognition of the speech signal of the specified utterance section of a user, utterance text generated by speech recognition of the speech signal of the specified utterance section of a user's conversation partner, an image signal of an image shot of a user, and/or an image signal of an image shot of a user's conversation partner, the state change detection unit 107, for example, detects a point of change in emotions and detects a point of change in conversation speed, by means of performing emotion analysis with a known method. The state change detection unit 107 then stores a change of state such as the point of change in emotions or point of change in conversation speed in the storage unit 119 together with the time when the change of state occurred.

The task set display information generation unit 109 generates display information for displaying a plurality of task fields in an order in which a plurality of tasks should be performed, the plurality of task fields respectively corresponding to the plurality of tasks which are set in the order in which the plurality of tasks should be performed. The task set display information generation unit 109 moreover generates display information for displaying a phase field in the order in which the phase field, which is set, should be performed, where the phase field corresponds to a phase configured from one or more of the plurality of tasks.

If it is determined for at least one task of a plurality of tasks that an utterance of a user, an image of a user, an utterance of a user's conversation partner, and/or an image of a user's conversation partner falls under any of one or more types of feature points in a conversation, the task state display information generation unit 111 generates display information for displaying indicators respectively corresponding to one or more types of feature points, in task fields each corresponding to at least one task. The task state display information generation unit 111 moreover generates display information for displaying information on tasks undertaken and/or information on tasks not undertaken, in a task field corresponding to a task determined to be a task which was undertaken and/or a task which was not undertaken. The task state display information generation unit 111 moreover generates display information for displaying at least one of a starting time of a task, an ending time of a task, and a handling time for a task, in a task field corresponding to a task of which at least one of the starting time, ending time, and handling time for a task is determined.

The conversation log display information generation unit 113 generates display information for displaying a conversation log acquired of a conversation between the user and the user's conversation partner. Moreover, in response to any of the indicators being pressed, the conversation log display information generation unit 113 generates display information for displaying the conversation log, focussing on an utterance of a user and/or an utterance of a user's conversation partner in a conversation log which corresponds to a feature point of the pressed indicator.

The phase/task transition monitoring unit 115 monitors the transition of a phase or task, which transitions in accordance with the progression of a conversation.

The transmission unit 117 transmits various items of information.

The storage unit 119 stores various items of information. The storage unit 117 may be configured as one physical apparatus, and may also be distributed and arranged in a plurality of physical apparatuses.

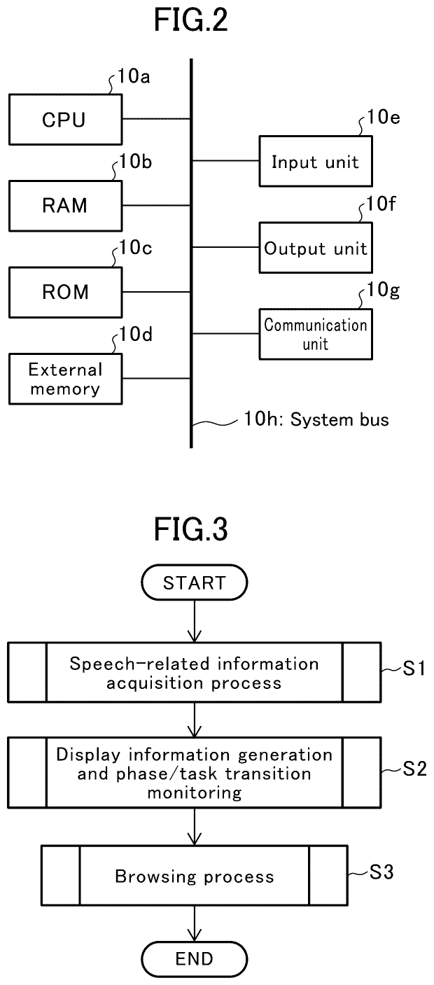

FIG. 2 illustrates a hardware configuration of a dialogue operation assistance system according to an embodiment of the present invention. The dialogue operation assistance system 1 includes a CPU 10a, RAM 10b, ROM 10c, external memory 10d, input unit 10e, output unit 10f and communication unit 10g. The RAM 10b, ROM 10c, external memory 10d, input unit 10e, output unit 10f and communication unit 10g are connected via a system bus 10h to the CPU 10a.

The CPU 10a integrally controls each device connected to the system bus 10h.

The BIOS and OS which are control programs of the CPU 10a, as well as various programs and data etc. necessary for achieving functions which are executed by a computer, are stored in the ROM 10c and external memory 10d.

The RAM 10b functions as the main memory and the work area etc. of the CPU. Upon executing a process, the CPU 10a loads the necessary programs etc. to the RAM 10b from the ROM 10c and external memory 10d, and achieves various operations by executing the loaded programs.

The external memory 10d is configured from, e.g., a flash memory, hard disk, DVD-RAM, USB memory etc.

The input unit 10e receives operating instructions etc. from a user, etc. The input unit 10e is configured from an input device such as, e.g., input button, keyboard, pointing device, wireless remote control, microphone, camera, etc.

The output unit 10f outputs data processed by the CPU 10a, or outputs data stored in the RAM 10b, ROM 10c or external memory 10d. The output unit 10f is configured from an output device such as, for example, an LCD or organic EL panel, printer, speaker etc.

The communication unit 10g is an interface for connecting and communicating with an external device, via a network or directly. The communication unit 10g is configured from an interface such as, for example, a serial interface, LAN interface etc.

All the units of the dialogue operation assistance system 1 are achieved by means of various programs stored in the ROM and external memory utilizing the CPU, RAM, ROM, external memory, input unit, output unit, communication unit etc., as resources.

On the premise of the above system configuration, an example of the dialogue operation assistance process of the dialogue operation assistance system according to an embodiment of the present invention will be explained below with reference to FIGS. 1 to 11B etc.

In the present embodiment, a case where a user conducts a conversation by receiving an enquiry of a product from a client who is a user's conversation partner will be explained as an example.

FIG. 3 is a schematic flowchart showing one example of a dialogue operation assistance process according to an embodiment of the present invention. The dialogue operation assistance process of the dialogue operation assistance system according to an embodiment of the present invention includes a speech-related information acquisition process (S1), a display information generation and phase/task transition monitoring process (S2), and a browsing process (S3). Each process will be explained in detail below.

### Speech-Related Information Acquisition Process

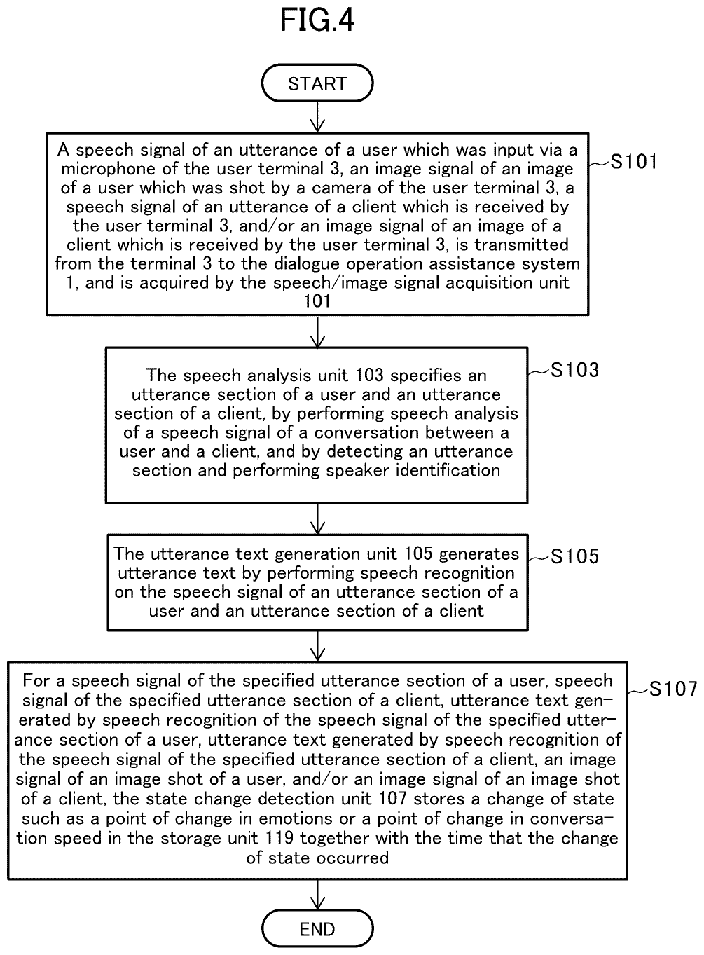

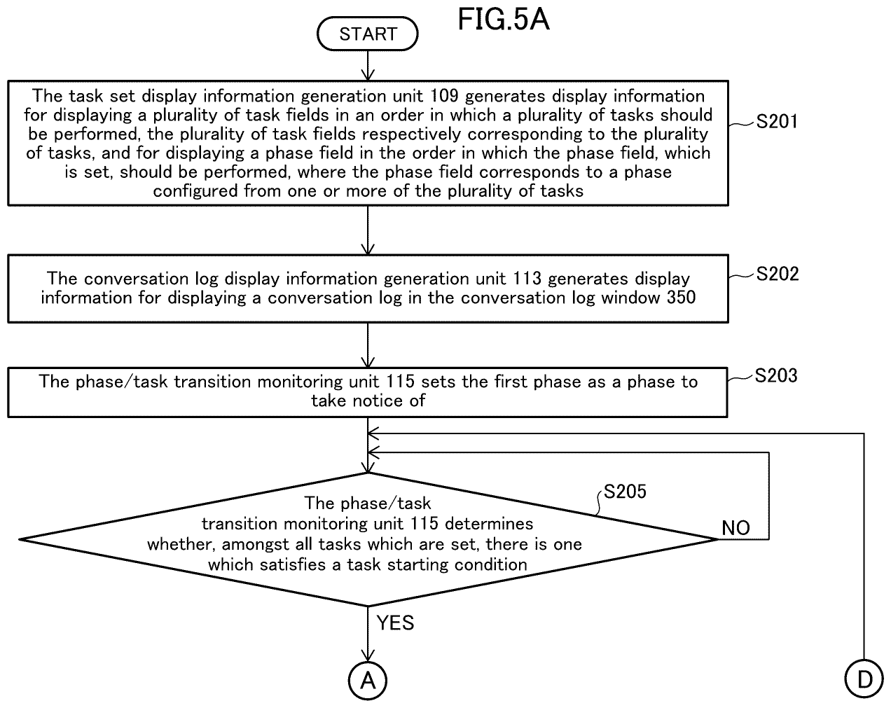

FIG. 4 is a flowchart showing one example of the speech-related information acquisition process according to an embodiment of the present invention.

A speech signal of an utterance of a user which is input via a microphone (not illustrated) of the user terminal 3, an image signal of an image of a user which is shot by a camera (not illustrated) of the user terminal 3, a speech signal of an utterance of a client who is a user's conversation partner which is received by the user terminal 3, and/or an image signal of an image of a client who is a user's conversation partner which is received by the user terminal 3, is transmitted from the terminal 3 to the dialogue operation assistance system 1, and is acquired by the speech/image signal acquisition unit 101 (S101). The speech signal and/or image signal acquired by the speech/image signal acquisition unit 101 is not limited to the aforementioned signals, and may be any other suitable speech signals of a conversation between a user and a user's conversation partner, image signals of an image shot of a user in a conversation between a user and a user's conversation partner, and/or image signals of an image shot of a user's conversation partner in a conversation between a user and a user's conversation partner. The above suitable speech signals and image signals include a speech signal of a conversation between a user and a client which is input via a microphone (not illustrated) of the user terminal 3, and/or an image signal of an image of a user and a client which is shot by a camera of the user terminal 3, in a conversation between a user and a client Moreover, a speech signal of a conversation between a user and a user's conversation partner acquired by the speech/image signal acquisition unit 101, an image signal of an image shot of a user in a conversation between a user and a user's conversation partner, and/or an image signal of an image shot of a user's conversation partner in a conversation between a user and a user's conversation partner may be any other suitable speech signals and/or image signals of a conversation between a user and any number of user's conversation partners.

The speech analysis unit 103 specifies an utterance section of a user and an utterance section of a client, by performing speech analysis of a speech signal acquired by the speech/image signal acquisition unit 101 of a conversation between a user and a client, and by detecting an utterance section and performing speaker identification (S103).

The utterance text generation unit 105 generates an utterance text by performing speech recognition on the speech signal of an utterance section of a user and the speech signal of an utterance section of a client, which are specified in S103 (S105).

For a speech signal of the specified utterance section of a user, speech signal of the specified utterance section of a client, utterance text generated by speech recognition of the speech signal of the specified utterance section of a user, utterance text generated by speech recognition of the speech signal of the specified utterance section of a client, an image signal of an image shot of a user, and/or an image signal of an image shot of a client, the state change detection unit 107, for example, detects a point of change in emotions and detects a point of change in conversation speed, by means of performing emotion analysis with a known method. The state change detection unit 107 then stores a change of state such as the point of change in emotions or point of change in conversation speed in the storage unit 119 together with the time that the change of state occurred (S107).

### Display Information Generation and Phase/Task Transition Monitoring Process

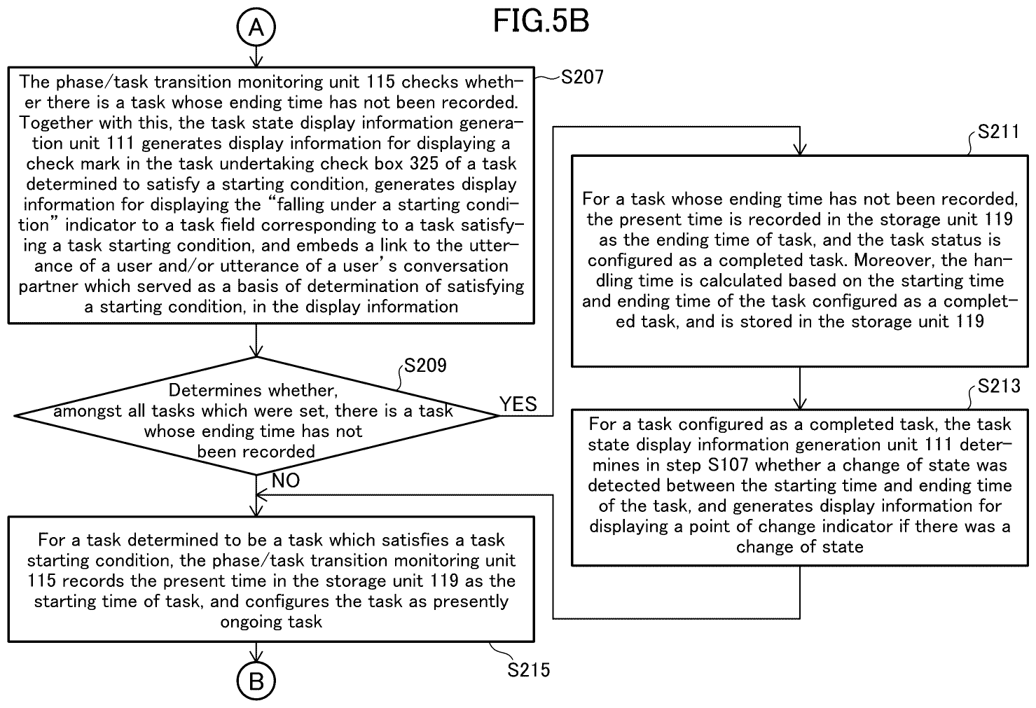

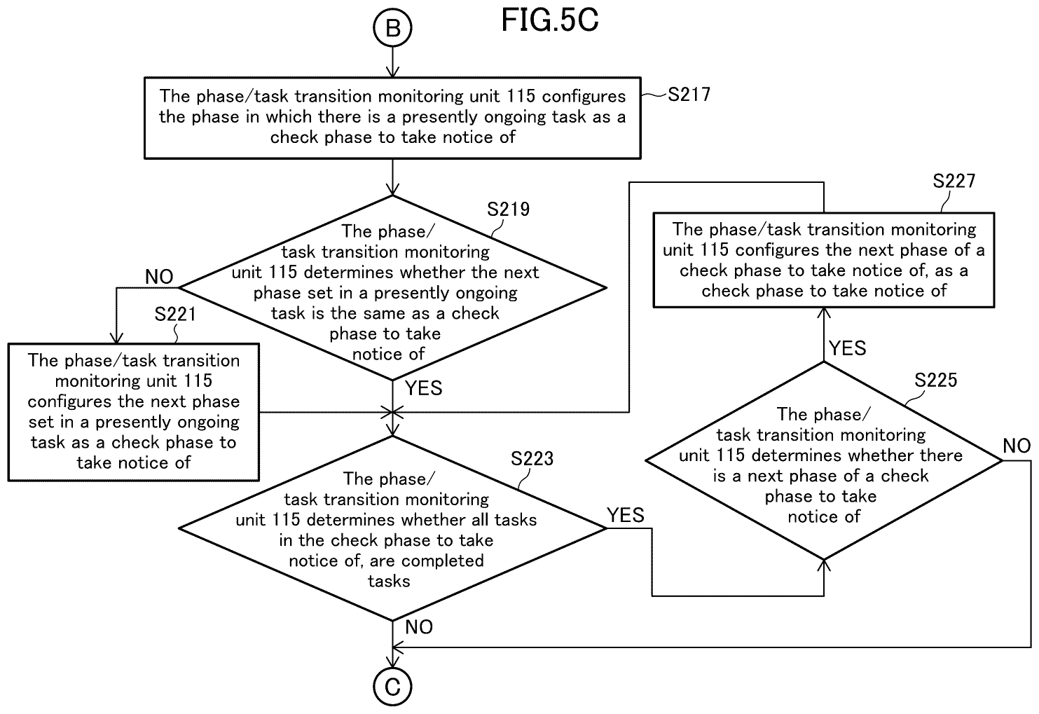

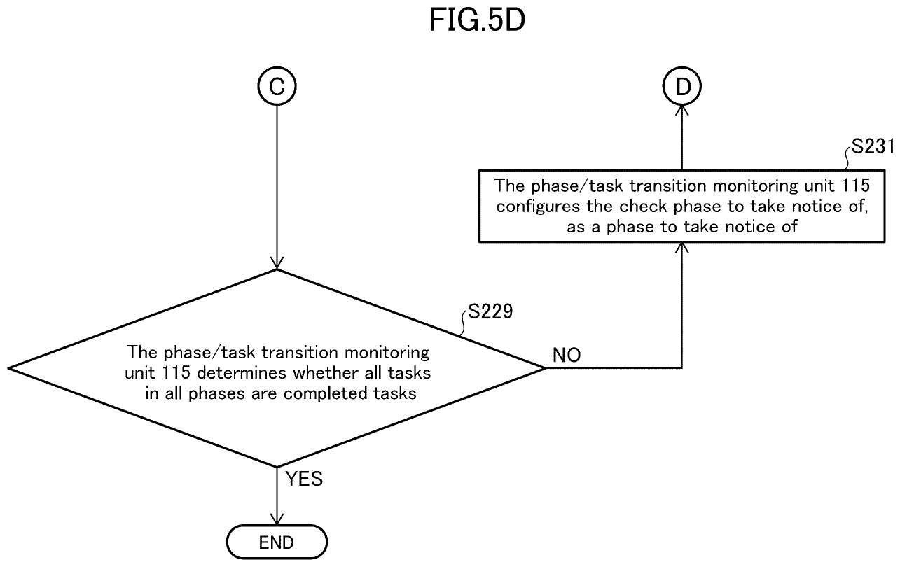

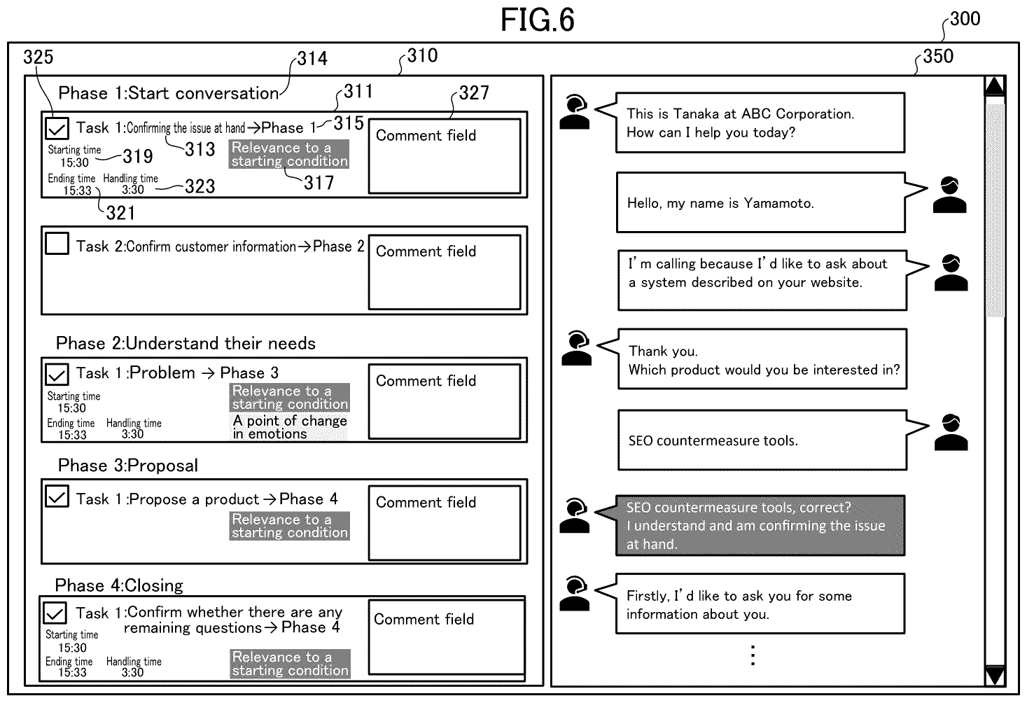

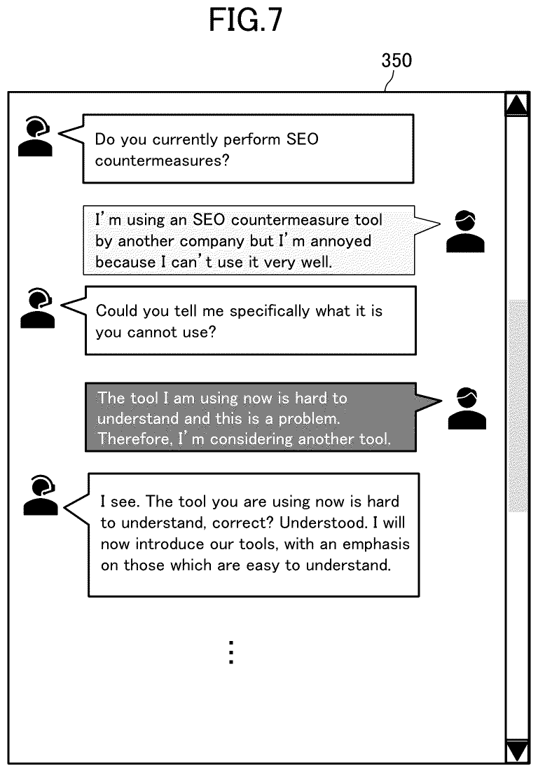

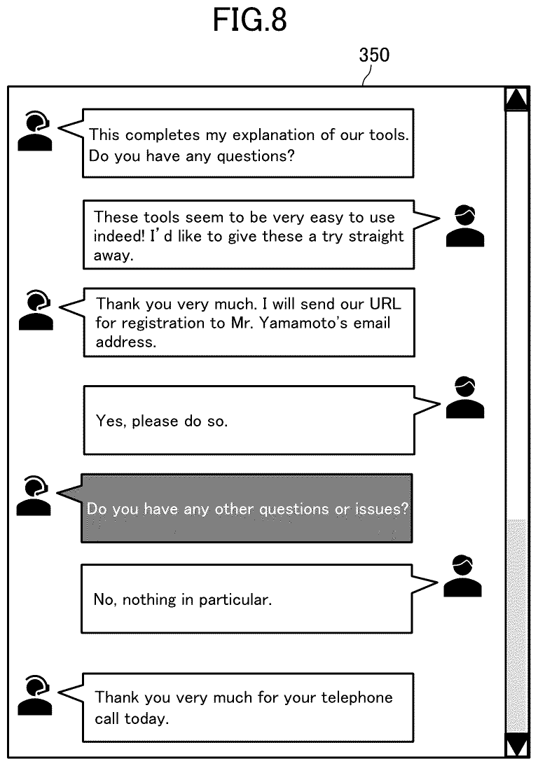

FIGS. 5A to 5D are flowcharts showing examples of a display information generation and phase/task transition monitoring process according to an embodiment of the present invention. FIG. 6 illustrates one example of a display screen 300 displayed on a display of the user terminal 3. FIGS. 7 and 8 each illustrate one example of a conversation log window displayed on a display of the user terminal according to an embodiment of the present invention. The display screen 300 includes a task set window 310 and a conversation log window 350, where the task set window 310 is arranged on the left side of the display screen 300, and the conversation log window 350 is arranged on the right side of the display screen 300. Moreover, because the entire conversation log cannot be displayed all at once in the conversation log window 350, the entire conversation log can be made to move to a desired portion by means of a scroll bar. The conversation log window 350 in FIG. 6 illustrates a portion of a conversation in the “start conversation” phase of “Phase 1”, the conversation log window 350 in FIG. 7 illustrates a portion of a conversation in the “understand their needs” phase of “Phase 2”, and the conversation log window 350 in FIG. 8 illustrates a portion of a conversation in the “closing” phase of “Phase 4”. The display modes of the task set window and conversation log window are not limited to the above ones and may be any other suitable display mode such as, e.g., a pop-up display.

The task set is a collection of a plurality of tasks that a user should take on for each theme, where tasks are set for each phase. A plurality of task fields 311 corresponding to the plurality of tasks that a user should take on is arranged in the task set window 310 in the order in which they should be performed. Then, as the task fields 311 are arranged for each phase, each phase field corresponding to each phase is arranged in the order in which it should be performed.

In the present embodiment, the theme of a task set is a “product enquiry”. As the phases, a “start conversation” phase is set as “Phase 1”, an “understand their needs” phase is set as “Phase 2”, a “proposal” phase is set as “Phase 3”, and a “closing” phase is set as “Phase 4”. These phases are set as those which should be performed in this order, and a corresponding phase field 314 is arranged in that order. Then, in “Phase 1”, a “confirming the issue at hand” task is set as “Task 1”, and a “confirming customer information” task is set as “Task 2”, where these two tasks are set as those which should be performed in this order. Further, in “Phase 2”, a “confirming what a customer considers a problem” task is set as “Task 1”, as a task which should be performed. Moreover, in “Phase 3”, a “confirming whether there are any remaining questions” task is set as “Task 1”, as a task which should be performed. Moreover, in each of the phase fields 314, the task field 311 corresponding to each task is arranged in the order in which it should be performed. Although each of the phase fields 314 and each of the task fields 311 are arranged in the order in which each phase and each task should be performed, this need not be each phase and each task being required to be actually performed in this order; rather the order in which they are actually performed can be changed depending on the situation thereof. Moreover, for phases and tasks which can be performed in parallel, there is no particular arrangement order of the corresponding phase fields and task fields.

In each of the task fields 311, each task 313, a next phase 315 which is the next advancing phase after each task 313 is finished, indicators 317 respectively corresponding to one or more types of feature points, which is displayed, while it is being identified that a task corresponding to a task field are being performed, when it is identified that an utterance of a user, utterance of a user's conversation partner, image of a user shot in a conversation between a user and a user's conversation partner, and/or image of a user's conversation partner shot in a conversation between a user and a user's conversation partner fall under any of one or more types of feature points in a conversation, a starting time of task 319 corresponding to a task field, an ending time of task 321 corresponding to a task field, a handling time 323 which is the time required to perform a task corresponding to a task field, a task undertaking check box 325, and a comment field 327 are displayed. In the comment field 327, a user and administrator can input a comment and an inputted comment is displayed.

In the present embodiment, a “falling under a starting condition” indicator for a starting condition which is a condition for which the task has been determined to have started, and a “point of change in emotions” indicator which is the point at which the emotions of a client was determined to have changed, are displayed as the indicator 317.

Meanwhile, the utterances of a user and a client which were converted into text data by the aforementioned speech-related information acquisition process are displayed time-sequentially in the conversation log window 350. The utterance of a user is displayed in a speech bubble from the left, and the utterance of a client is displayed in a speech bubble from the right. Here, the display mode of the utterance of a user and utterance of a client is not limited to this, and the utterance of a user and utterance of a client may be any other suitable display mode to allow to distinguish the utterance of a user from the utterance of a client. When it is identified that the erance of a user, utterance of a user's conversation partner, image of a user shot in a conversation between a user and a user's conversation partner, and/or image of a user's conversation partner shot in a conversation between a user and a user's conversation partner fell under any of one or more types of feature points in a conversation, the color of a corresponding speech bubble is changed to the same color as that of the corresponding indicator and is displayed. The change of the display mode of this corresponding speech bubble is not limited to this, and may be any other suitable display mode change which is visually distinguishable such as a change to another color, or blinking.

One example of a process of generating display information for displaying the above display screen and a process for monitoring the transition of a phase and task, will be explained as follows.

A task set is a collection of a plurality of tasks that a user should take on for each theme, where tasks are set for each phase. In the present embodiment, the theme of the task set is a “product enquiry”, the “start conversation” phase is set as “Phase 1”, the “understand their needs” phase is set as “Phase 2”, the “proposal” phase is set as “Phase 3”, and the “closing” phase is set as “Phase 4”. They are set as the phases which should be performed in this order, and are stored in the storage unit 119.

Then, in “Phase 1”, the “confirming the issue at hand” task is set as “Task 1” and the “confirming customer information” task is set as “Task 2”. These two tasks are set as those which should be performed in this order. In “Phase 2”, the “confirming a problem” task is set as “Task 1”, as a task which should be performed. In “Phase 3”, the “confirming whether there are any remaining questions” task is set as “Task 1”, as a task which should be performed. In this way, one or a plurality of tasks are set with respect to each phase, and are stored in the storage unit 119.

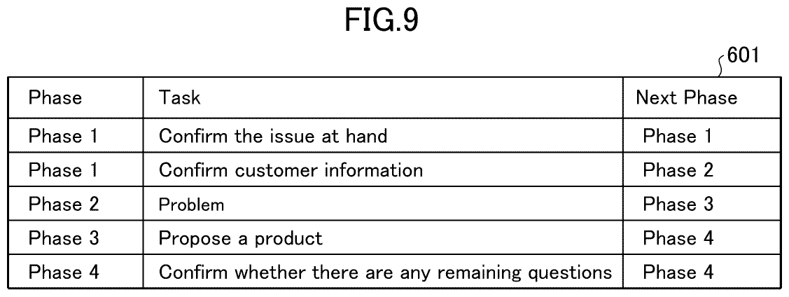

Moreover, as in the next phase table 601 illustrated in FIG. 9, the next phase 315, which is the next advancing phase after each task 313 is finished, is set with respect to each corresponding task, and is stored in the storage unit 119.

The task set display information generation unit 109 generates display information for displaying a plurality of task fields in an order in which a plurality of tasks should be performed, the plurality of task fields respectively corresponding to the plurality of tasks which are set in the order in which the plurality of tasks should be performed. The task set display information generation unit 109 moreover generates display information for displaying a phase field in the order in which the phase field, which is set, should be performed, where the phase field corresponds to a phase configured from one or more of the plurality of tasks (S201). Specifically, the task set display information generation unit 109 generates task set window display information which includes: a corresponding phase field and task field, as well as a next phase, based on a phase which is set in the order in which the phase should be performed; a task which is set in the order in which the task should be performed for each phase; and a next phase which is set for each task, which are stored in the storage unit 119 as mentioned above. The display information to be generated may also be, e.g., information of a screen image itself, or may also be information for displaying a portion of information, where a terminal in which a screen image is displayed has a portion of the information relating to the screen image, together with that screen image.

Meanwhile, the conversation log display information generation unit 113 generates display information for displaying a conversation log acquired by the aforementioned speech-related information acquisition process, of a conversation between a user and a client, in the conversation log window 350 (S202). As mentioned above, the utterances of a user and a client which are converted into text data by the aforementioned speech-related information acquisition process are displayed time-sequentially in the conversation log window 350. The utterance of a user is displayed in a speech bubble from the left, and the utterance of a client is displayed in a speech bubble from the right. Here, the display mode of the utterance of a user and utterance of a client is not limited to this, and may be configured as any other suitable display mode of which an utterance of a user and an utterance of a client are distinguishable. If it is identified that an utterance of a user, utterance of a user's conversation partner, image of a user shot in a conversation between a user and a user's conversation partner, and/or image of a user's conversation partner shot in a conversation between a user and a user's conversation partner fall under any of one or more types of feature points in a conversation, the corresponding color of a speech bubble is changed to the same color as that of the corresponding indicator and is displayed. The change of the display mode of this corresponding speech bubble is not limited to this, and may be any other suitable display mode change which is visually distinguishable such as a change to another color, or blinking.

Each generated display information is transmitted to the user terminal 3 by means of the transmission unit 117, and is displayed on a display of the user terminal 3.

The display information for displaying task states such as the “falling under a starting condition” indicator, task undertaking check box, starting time, ending time etc. in the relevant task field is generated as follows.

Firstly, the phase/task transition monitoring unit 115 sets the first phase (the “start conversation” phase which is “Phase 1” in the present embodiment) as a phase to take notice of (S203).

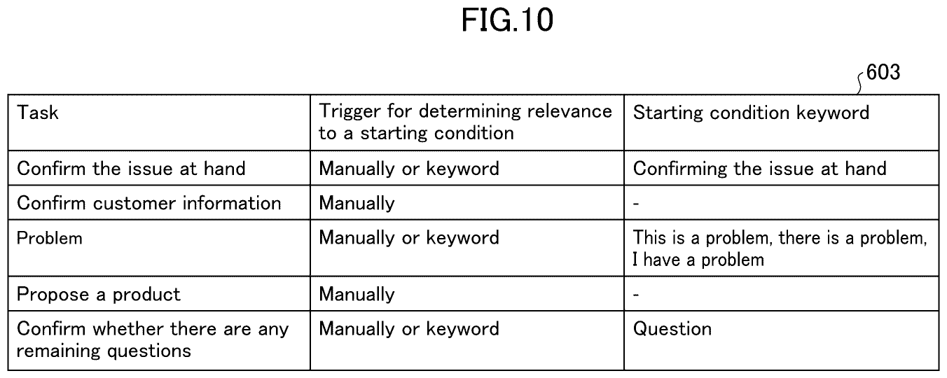

Next, the phase/task transition monitoring unit 115 determines whether, amongst all tasks which are set, there is one which satisfies a task starting condition (S205). Specifically, as illustrated in FIG. 10, tasks and the starting condition keywords for identifying the start of the tasks are mapped and stored in the storage unit 119 as a starting condition keyword table 603. If any starting condition keyword is found for the first time in a user's utterance text and/or a client's utterance text, it is identified that a task corresponding to that starting condition keyword satisfies the starting condition. However, for a task that cannot be identified very well by a keyword as to whether it satisfies a starting condition, no corresponding keyword is stored in the starting condition keyword table 603, and a user performs a setting manually such that a starting condition is satisfied, e.g., by pressing a task check box 325, etc. Moreover, in addition to identification by a keyword, a user can also perform setting manually such that a starting condition is satisfied. Identifying whether a starting condition is satisfied by any of these triggers is also mapped to a task in the starting condition keyword table 603. Determining whether a task satisfies a starting condition is not limited to determination by means of keyword matching, but can be determined by any other suitable method.

If there is no task which satisfies a task starting condition (S205-No), the determination of whether, amongst all tasks which were set, there is one which satisfies a task starting condition, continues.

If there is a task which satisfies a task starting condition (S205-Yes), the phase/task transition monitoring unit 115 checks whether there is a task whose ending time has not been recorded. Together with this, the task state display information generation unit 111 generates display information for displaying a check mark in the task undertaking check box 325 of a task determined to satisfy a starting condition, generates display information for displaying the “falling under a starting condition” indicator in a task field corresponding to a task satisfying a task starting condition, and embeds a link to the utterance of a user and/or utterance of a user's conversation partner which served as a basis of determination of satisfying a starting condition, in the display information (S207). The method of mapping of an indicator to the utterance of a user and/or utterance of a user's conversation partner which served as a basis of determining a point of change is not limited to a link, but can be any other suitable configuration such as, e.g., a configuration of mapping both parties and storing them in the storage unit, referring to the stored correspondence in that storage unit, and determining the utterance of a user and/or utterance of a user's conversation partner which served as a basis of determination of a point of change corresponding to an indicator. Moreover, the information on tasks undertaken and/or information on tasks not undertaken is not limited to a configuration of displaying a check mark in the task undertaking check box, but may be a configuration of displaying a check mark to a task not undertaken, or may be any other suitable configuration such as appending an ‘undertaken’ mark to tasks undertaken, and an ‘incomplete’ mark to tasks not undertaken. Moreover, if a check mark is displayed in the task undertaking check box 325, the task may be deemed to be not only to have been undertaken, but that the task was finished, and in that case, the task undertaking check box would have the meaning of a finished task check box.

For example, an utterance text of “SEO countermeasure tools, correct? I understand and am confirming the issue at hand.” by a user includes the keyword of “confirming the issue at hand” amongst the starting condition keywords stored in the starting condition keyword table 603 of the storage unit 119. Therefore, the task of “confirming the issue at hand” corresponding to the keyword of “confirming the issue at hand” is determined to satisfy a starting condition, display information for displaying the “falling under a starting condition” indicator is generated, a link to the utterance of “SEO countermeasure tools, correct? I understand and am confirming the issue.” of a user is embedded in the display information, and the display information for changing the color of this utterance to the same color as that of the relevant indicator is generated. Similarly, in relation to the conversation log of the “understand their needs” phase in FIG. 7, based on the fact that the utterance of “The tool I am using now is hard to understand, and this is a problem. Therefore, I'm considering another tool.” includes a starting condition keyword of “this is a problem”, the task of “confirming a problem” is determined to satisfy a starting condition, the display information for displaying the “falling under a starting condition” indicator is generated, a link to the relevant utterance of a user is embedded in the display information, and display information for changing the color of this utterance to the same color as that of the relevant indicator is generated. Moreover, because a point of change in emotions was detected by the change of state detection unit 107 at the time of the utterance of “I'm using an SEO countermeasure tool by another company but I'm annoyed because I can't use it very well.”, display information for displaying the “point of change in emotions” indicator is generated, a link to the relevant utterance of a client is embedded in the display information, and display information for changing the color of this utterance to the same color as that of the relevant indicator is generated. Moreover, in relation to the conversation log of the “closing” phase in FIG. 8, based on the fact that the utterance of “Do you have any questions or any other issues?” includes the starting condition keyword of “question”, the task of “confirming whether there are any remaining questions” is determined to satisfy a starting condition, display information for displaying the “falling under a starting condition” indicator is generated, a link to the relevant utterance of a user is embedded in the display information, and display information for changing the color of this utterance to the same color as that of the relevant indicator is generated.

Next, the phase/task transition monitoring unit 115 determines whether, amongst all tasks which were set, there is a task whose ending time has not been recorded (S209).

If there is a task whose ending time has not been recorded (S209-Yes), for a task whose ending time has not been recorded, the present time is recorded in the storage unit 119 as the ending time of task, and the task status is configured as a completed task in the storage unit 119. Moreover, the handling time is calculated and stored in the storage unit 119, based on the starting time and ending time of the task, which was configured as a completed task (S211).

For a task configured as a completed task, the task state display information generation unit 111 determines in step S107 whether a change of state was detected between the starting time and ending time of the task recorded in the storage unit 119, generates display information for displaying a point of change indicator (e.g., “a point of change in emotions” indicator) if there was a change of state (S213), and advances to step S215.

For a task determined to be a task satisfying a task starting condition in step S205, if there is no task whose ending time has not been recorded (S209-No), the phase/task transition monitoring unit 115 records the present time in the storage unit 119 as a starting time of task, and configures the task as presently ongoing task (S215).

The phase/task transition monitoring unit 115 configures a phase in which there is a presently ongoing task as a check phase to take notice of (S217).

The phase/task transition monitoring unit 115 determines whether a next phase set in a presently ongoing task is the same as a check phase to take notice of (S219).

If a next phase set in a presently ongoing task is not the same as a check phase to take notice of (S219-No), the phase/task transition monitoring unit 115 configures a next phase set in a presently ongoing task as a check phase to take notice of, and advances to step S221.

If the next phase set in a presently ongoing task is the same as a check phase to take notice of (S219-Yes), the phase/task transition monitoring unit 115 determines whether all tasks in the check phase to take notice of are completed tasks (S223).

If all tasks in the check phase to take notice of are completed tasks (S223-Yes), the phase/task transition monitoring unit 115 determines whether there is a next phase of a check phase to take notice of (S225).

If there is no next phase of a check phase to take notice of (S225-No), the phase/task transition monitoring unit 115 advances to step S229.

If there is a next phase of a check phase to take notice of (S225-Yes), the phase/task transition monitoring unit 115 configures the next phase of a check phase to take notice of, as a check phase to take notice of (S227), and returns to step S223.

In step S223, if none of the tasks in the check phase to take notice of have become completed tasks (S223-No), the phase/task transition monitoring unit 115 determines whether all tasks in all phases are completed tasks (S229).

If all tasks in all phases are completed tasks (S229-Yes), the display information generation and phase/task transition monitoring process ends.

If none of the tasks in all phases have become completed tasks (S229-No), the check phase to take notice of is configured as a phase to take notice of (S231), and the phase/task transition monitoring unit 115 returns to step S205.

### Browsing Process

Information relating to a conversation which a user conducted with a client is stored in the storage unit 119 by means of the aforementioned speech-related information acquisition process and the display information generation and phase/task transition monitoring process; and a user or administrator can browse the situation of the conversation based on the information relating to the conversation between a user and a client stored in this storage unit 119.

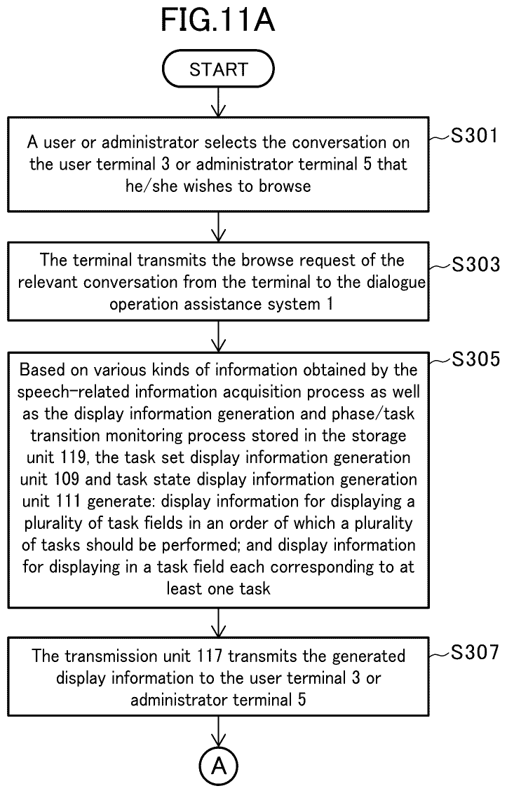

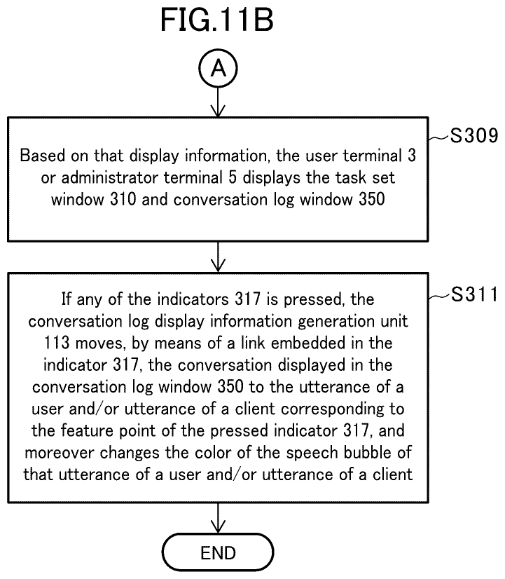

FIGS. 11A and 11B are flowcharts showing one example of the browsing process according to an embodiment of the present invention.

When a user or administrator selects the conversation on the user terminal 3 or administrator terminal 5 that he/she wishes to browse (S301), the terminal transmits the browse request of the relevant conversation from the terminal to the dialogue operation assistance system 1 (S303). Then, the task set display information generation unit 109 and task state display information generation unit 111 generate: display information for displaying a plurality of task fields in an order in which a plurality of tasks should be performed; and display information for displaying in a task field each corresponding to the at least one task, based on various kinds of information obtained by the aforementioned speech-related information acquisition process, as well as the display information generation and phase/task transition monitoring process stored in the storage unit 119 (S305). The transmission unit 117 transmits the generated display information to the user terminal 3 and administrator terminal 5 (S307). Based on that display information, the user terminal 3 and administrator terminal 5 display the task set window 310 and the conversation log window 350 similarly to that in FIG. 6 (S309).

Moreover, if any of the indicators 317 is pressed by a user or administrator, the conversation log display information generation unit 113 moves, by means of the link embedded in the indicator 317, the conversation displayed in the conversation log window 350 to the utterance of a user and/or utterance of a client corresponding to the feature point of the pressed indicator 317, and moreover changes the color of the speech bubble of that utterance of a user and/or utterance of a client (S311). The method of focussing on the utterance of a user and/or utterance of a user's conversation partner in a conversation log corresponding to a feature point of the pressed indicator is not limited to this, but may be configured as any other suitable method such as, e.g., not displaying the conversation log window by default, but displaying by a pop-up an utterance of a user and/or utterance of a user's conversation partner in a conversation log corresponding to a feature point of the pressed indicator, in response to an indicator being pressed, etc.

According to the present embodiment, a user can perform a dialogue operation whilst he/she can easily grasp the situation relating to the accomplishment of tasks such as grasping: the tasks for which a discussion was completed; the tasks for which a discussion should be held next; whether there are tasks which have not yet been discussed; whether the time allocation per task is going smoothly, etc.

Moreover, according to the present embodiment, a task field arranged in the order in which a task should be performed is displayed and information showing the task state is displayed in the task field, hence an overview of the flow and content of a conversation (in the present embodiment, the flow and content of a business discussion) can be easily grasped. Together with this, moreover, by pressing an indicator, a conversation displayed in a conversation log window is displayed, focussing on the portion corresponding to feature point shown by the indicator; hence even if a conversation log window is not fitted in a display screen as illustrated in FIGS. 6 to 8, details of the corresponding conversation can be immediately confirmed. In other words, both the overview and the details of the flow and content of a conversation can be easily grasped, and visual recognizability is excellent.

In the aforementioned embodiment, although the target conversation was a conversation based on speech, there is no limitation to this, and a text data based chat, for example, may also be configured as the target.

In the aforementioned embodiment, there is a configuration of display information generated by means of the dialogue operation assistance system being transmitted to a terminal, but some or all of the functions of the dialogue operation assistance system may also be loaded on a terminal.

Although the present invention was explained above in relation to several embodiments for the purpose of exemplification, the present invention is not restricted to this; and it would be obvious to the person skilled in the art that various modifications and corrections can be performed on the form and details without deviating from the scope and spirit of the present invention.

### REFERENCE SIGNS LIST

1 Dialogue operation assistance system
101 Speech/image signal acquisition unit
103 Speech analysis unit
105 Utterance text generation unit
107 Change of state detection unit
109 Task set display information generation unit
111 Task state display information generation unit
113 Conversation log display information generation unit
115 Phase/task transition monitoring unit
117 Transmission unit
119 Storage unit
10a CPU
10b RAM
10c ROM
10d External memory
10e Input unit
10f Output unit
10g Communication unit
10h System bus
2 Network
3 User terminal
300 Display screen
310 Task set window
311 Task field
313 Task
314 Phase field
315 Next phase
317 Indicator
319 Starting time of task
321 Ending time of task
323 Handling time
325 Task undertaking check box
327 Comment field
350 Conversation log window
4 Client terminal
5 Administrator terminal
601 Next phase table
603 Starting condition keyword table

What is claimed is:

1. A dialogue operation assistance system for assisting a dialogue operation in which a user is engaged, wherein the system comprises:
at least one processor.
at least one storage; and
program instructions stored in the at least one storage and executable by the at least one processor to carry out operations including:
generating display information for displaying a conversation log acquired of a conversation between said user and said user's conversation partner;
generating display information for displaying a plurality of task fields in an order in which a plurality of tasks should be performed, said plurality of task fields respectively corresponding to said plurality of tasks which are set in the order in which said plurality of tasks should be performed;
If it is determined for at least one task of said plurality of tasks that an utterance of said user, an image of said user, an utterance of said user's conversation partner, and/or an image of said user's conversation partner falls under any of one or more types of feature points in a conversation, generating display information for displaying indicators respectively corresponding to said one or more types of feature points, in task fields each corresponding to said at least one task; and,
in response to any of said indicators being pressed, generating display information for displaying said conversation log, focussing on an utterance of said user and/or an utterance of said user's conversation partner in said conversation log which corresponds to said feature point of said pressed indicator.

2. The dialogue operation assistance system according to claim 1, wherein the operations further comprising generating display information for displaying a phase field in the order in which the phase field, which is set, should be performed, the phase field corresponding to a phase configured from one or more of said plurality of tasks.

3. The dialogue operation assistance system according to claims 1, wherein said conversation log is conversation text data obtained by speech recognition of a speech signal of a conversation between said user and said user's conversation partner.

4. The dialogue operation assistance system according to claims 1, wherein the operations further comprising generating display information for displaying information on a task undertaken and/or information on a task not undertaken, in a task field corresponding to a task determined to be a task which was undertaken and/or a task which was not undertaken.

5. The dialogue operation assistance system according to claims 1, wherein the operations further comprising generating display information for displaying at least one of a starting time of a task, an ending time of a task, and a time for dealing with a task, in a task field corresponding to a task of which at least one of said starting time, ending time, and time for dealing with a task is determined.

6. The dialogue operation assistance system according to claims 1, wherein said feature point of said indicator is a task starting condition is satisfied.

7. The dialogue operation assistance system according to claims 1, wherein said feature point of said indicator is a point of change in emotions and/or a point of change in conversation speed.

8. A dialogue operation assistance method performed by a computer for assisting a dialogue operation in which a user is engaged, wherein said method includes:
generating display information for displaying a conversation log acquired of a conversation between said user and said user's conversation partner:
generating display information for displaying a plurality of task fields in an order in which a plurality of tasks should be performed, said plurality of task fields respectively corresponding to said plurality of tasks which were set in the order in which said plurality of tasks should be performed:
if it is determined for at least one task of said plurality of tasks that an utterance of said user, an image of said user, an utterance of said user's conversation partner, and/or an image of said user's conversation partner is relevant to any of one or more types of feature points in a conversation, generating display information for displaying indicators respectively corresponding to said one or more types of feature points, in a task field each corresponding to said at least one task: and
in response to any of said indicators being pressed, generating display information for displaying said conversation log, focussing on an utterance of said user and/or an utterance of said user's conversation partner in said conversation log which corresponds to said feature point of said pressed indicator.

9. The dialogue operation assistance method according to claim 8, further including generating display information for displaying a phase field in the order in which the phase field, which was set, should be performed, the phase field corresponding to a phase configured from one or more of said plurality of tasks.

10. The dialogue operation assistance method according to claims 8, wherein said conversation log is conversation text data obtained by speech recognition of a speech signal of a conversation between said user and said user's conversation partner.

11. The dialogue operation assistance method according to claims 8, further including generating display information for displaying information on a task undertaken and/or information on a task not undertaken, in a task field corresponding to a task determined to be a task which was undertaken and/or a task which was not undertaken.

12. The dialogue operation assistance method according to claims 8, further including generating display information for displaying at least one of a starting time of a task, an ending time of a task, and a handling time for a task, in a task field corresponding to a task of which at least one of said starting time of task, ending time of task, and handling time for a task was determined.

13. The dialogue operation assistance method according to claims 8, wherein said feature point of said indicator is that a task starting condition is satisfied.

14. The dialogue operation assistance method according to claims 8, wherein said feature point of said indicator is a point of change in emotions and/or a point of change in conversation speed.

15. (canceled)

16. A non-transitory computer readable recording medium having recorded thereon a computer program for causing a computer to perform the method according to claims 8.

17. (canceled)
